(19) United States
(12) Patent Application Publication
(10) Pub. No.: US 2013/0013585 A1
(43) Pub. Date: Jan. 10, 2013

(54) HASH JOIN AND HASH AGGREGATION INTEGRATION SYSTEM

(76) Inventor: Goetz Graefe, Madison, WI (US)

(21) Appl. No.: 13/178,994

(22) Filed: Jul. 8, 2011

(51) Int. Cl. G06F 17/30

(52) U.S. Cl. 707/714; 707/E17.054

(57) ABSTRACT

A hash integration system includes a hash join module including build and probe inputs. A hash aggregation module may aggregate on the probe input of the hash join module, and a hash table generation module may generate an integrated hash table including a record with values from the build and aggregated probe inputs. The hash join module may join the build and aggregated probe inputs to form a joined output.

### BACKGROUND

In database query processing and similar tasks, complex query execution plans may include multiple operations such that the output of one operation is the input of the next operation. Such intermediate query results may be stored or pipelined, and may include a single data structure of individual results, or of multiple data structures each containing multiple records.

As an operation obtains the items in one of its input streams, it may group items by some criterion or predicate. One example is a SQL “distinct” query. Some summary information may be derived from the items in a group, e.g., a sum or an average. One example is a SQL “group by” query. An operation with multiple inputs, for example two inputs, may match up items from the two input based on some criterion or predicate. One example may include a SQL “join” query, including the variants of “outer joins.”

Joins may also be derived from other types of query formulations, e.g., semi joins from “in” and “not in” queries in SQL. Set operations such as intersections may be requested explicitly, e.g., using SQL “intersect” syntax, or may be employed without explicit request, e.g., when intersecting lists of items, each list capturing the result set for a component of a conjunction.

A process of data manipulation operations may define the semantics of the operations and permit algebraic manipulations or rewrites of expressions in the algebra. Thus, it may be possible and beneficial to rewrite the original expression. One type of optimization may be to reduce data volumes early during expression evaluation. In other words, grouping operations that replace entire groups of records with a single summary record may be performed as early as possible, with join operations afterwards. In other words, aggregation operations on join inputs are not uncommon, in particular after optimization has been applied to the original request. Optimization may be automatic or by human effort.

In addition to database query processing, other systems employ multiple operations to satisfy entire requests, pass intermediate results between operations, and perform grouping and join operations or very similar operations in which items are matched based on a criterion or predicate. One example includes “map-reduce” data processing for “big data” in “cloud computing.”

In the sequel, database query processing may stand for any processing graph in which operations pass intermediate results as streams of information items, aggregation may stand for any operation grouping items from one input, and a join with two inputs may stand for any operation matching items from two or more inputs. The user request, database query, or overall problem may be of sufficient complexity that at least one join operation is performed and that aggregation is performed on at least two inputs. Thus separate hash tables and memory allocations may be needed for the join and aggregation operations, which can add additional expenses to a system and delay query processing.

### BRIEF DESCRIPTION OF DRAWINGS

The embodiments are described in detail in the following description with reference to the following figures.

FIG. 1 illustrates a hash join and hash aggregation integration system, according to an embodiment;

FIG. 2 illustrates an example of a query in SQL syntax, according to an embodiment;

FIG. 3 illustrates an example of an equivalent query execution plan and record formats of intermediate results, according to an embodiment;

FIG. 4 illustrates a query that joins two tables, according to an embodiment;

FIG. 5 illustrates an example of a query execution plan for the query of FIG. 4, including the record formats after each step, according to an embodiment;

FIG. 6 illustrates a complex query, according to an embodiment;

FIG. 7 illustrates an example of a query execution plan for the query of FIG. 6, according to an embodiment;

FIG. 8 illustrates an example of a query execution plan for the complex query of FIG. 6, according to an embodiment;

FIG. 9 illustrates a method for integration of hash join and hash aggregation, according to an embodiment; and

FIG. 10 illustrates a computer system that may be used for the method and system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

### 1. Overview

Data and information processing systems may match records from a single dataset, for example for grouped aggregation or for duplicate removal, or from multiple datasets, for example for join or intersection operations. Processes based on hash partitioning and on hash tables, for example hash join and hash aggregation, can integrate single-input operations and multi-input operations beyond previously accepted limitations.

If all inputs are sorted on their match attributes, order-based processes tend to be efficient. Aggregation can be performed immediately on the sorted inputs and the subsequent join operations can be realized with a merging process. In the sequel, examples of cases may include cases in which none or only some of the inputs are appropriately sorted.

If some or all inputs are not sorted, hash-based processes tend to be efficient. In those processes, a hash value may be computed for each input item from the input item's matching attribute. This hash value may be used both for hash partitioning (for large inputs) and for insertion and search in an in-memory hash table (for small inputs and for partitions). Partitioning effort may be reduced or avoided if the required hash tables are few and small. In the sequel, one consideration may be to reduce the count and sizes of the required hash tables.

According to an embodiment, a hash join and hash aggregation integration system (hereinafter “hash integration system”) integrates hash join and hash aggregation, and allows for hash aggregation to be applied to one or both join inputs in hash join. The hash integration system further allows for role reversal to be applied to any hash join. The role reversal may also be applied to a hash join including aggregation on one or both inputs.

The hash integration system may include appropriate information from the probe input within records retained in a hash table that is central to hash join and hash aggregation, and may perform final calculations when an output record is produced from a record in the hash table. The hash table constructed with records from the build input may contain additional fields (not present or derived from the build input) in order to accommodate aggregated information from records of the probe input. The fields may depend on the query at hand. For example, the fields may be the same as the fields in an aggregation of the input in a query execution plan with a join and two separate aggregation operations. These fields may include the grouping values and the partial aggregation values (e.g., a sum and a count). Final calculations may be performed before output is produced. For example, the sum and count may be divided to obtain an average. Each record of the probe input may match with multiple records of the build input and may therefore contribute to the aggregation calculations in multiple records in the hash table.

The hash integration system provides improved query processing performance by integrating hash join and hash aggregation. For the hash integration system, query execution run-time can apply role reversal if warranted even in join operations with integrated aggregation. Thus the hash integration system provides a single operation that can accomplish computations previously using multiple operations. The reduction to a single operation reduces effort for data transfer as well as effort and memory for hash tables.

### 2. System

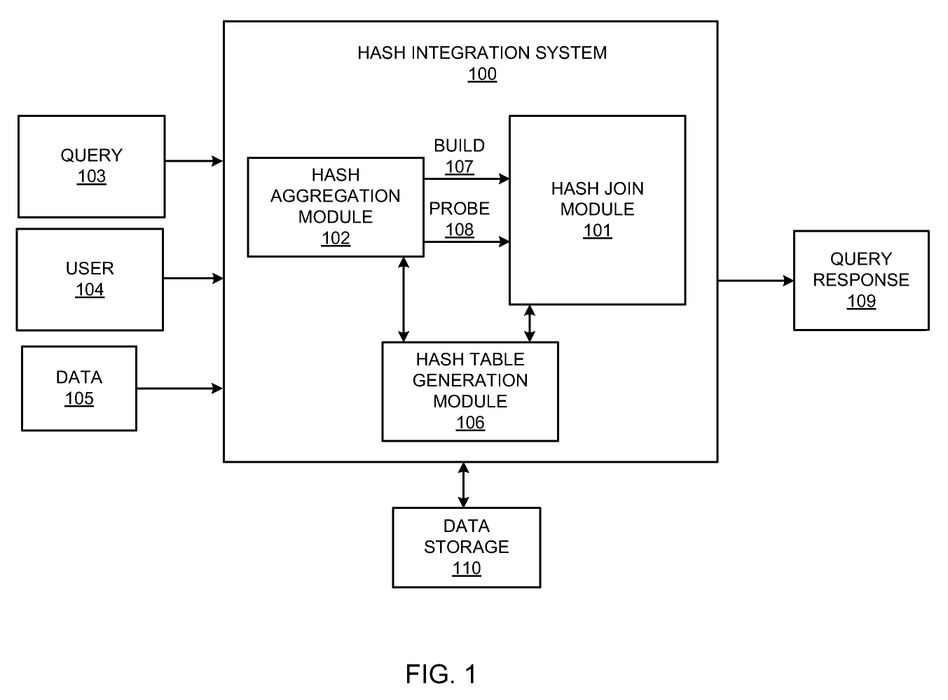

FIG. 1 illustrates a hash integration system 100, according to an embodiment. The system 100 may include a hash join module 101 and a hash aggregation module 102 to execute a query 103 by a user 104 pertaining to data 105. The modules and other components of the system 100 may include machine readable instructions, hardware or a combination of machine readable instructions and hardware. As described below, a hash table generation module 106 may generate an integrated hash table including a record with an aggregation column from probe input 108 or aggregation columns from build and probe inputs 107, 108, respectively, of the hash join module 101. The results of the query 103 may be generated at a query response 109. The system 100 may include a data storage 110, and include a database or other type of data management system.

Various aspects related to the system 100 are described before proceeding with a further description of the foregoing modules.

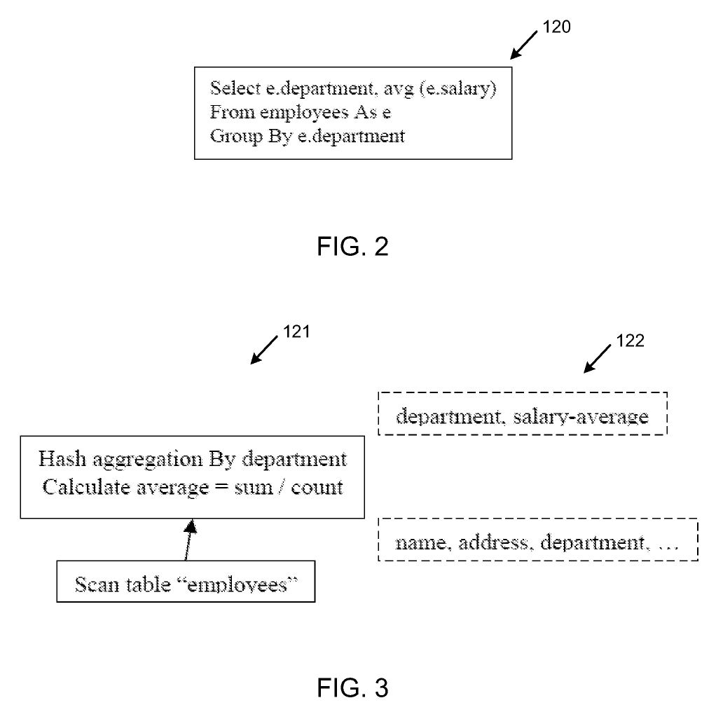

FIG. 2 illustrates an example of a query 120 in SQL syntax, according to an embodiment. As shown in FIG. 2, a grouping query partitions all rows in an employee table and, for each department, calculates the average salary. For example, for a table of employees including names, addresses, employment year, department ID, and salary, grouping may include determination of an average salary per department. In order to determine the average salary per department, records that have the same department ID may be brought together. For multiples of such records, the salaries may be added and counted. An average salary per department may be computed. Other query systems offer similar functionality with their own specific syntax. This functionality is closely related to “big data” processing and specifically the “reduce” operations in modern-day ‘map-reduce’ style.

FIG. 3 illustrates an example of an equivalent query execution plan 121 (solid) and record formats 122 (dashed) of intermediate results, according to an embodiment. In the relationship between the two operations, the bottom box is the producer and the top box is the consumer. In other words, data flows bottom-up (solid arrow). In many implementations, control flows top-down (not shown in the illustration). Thus, the consumer operation is driven by appropriate method invocations. These methods produce data items when they return to the caller.

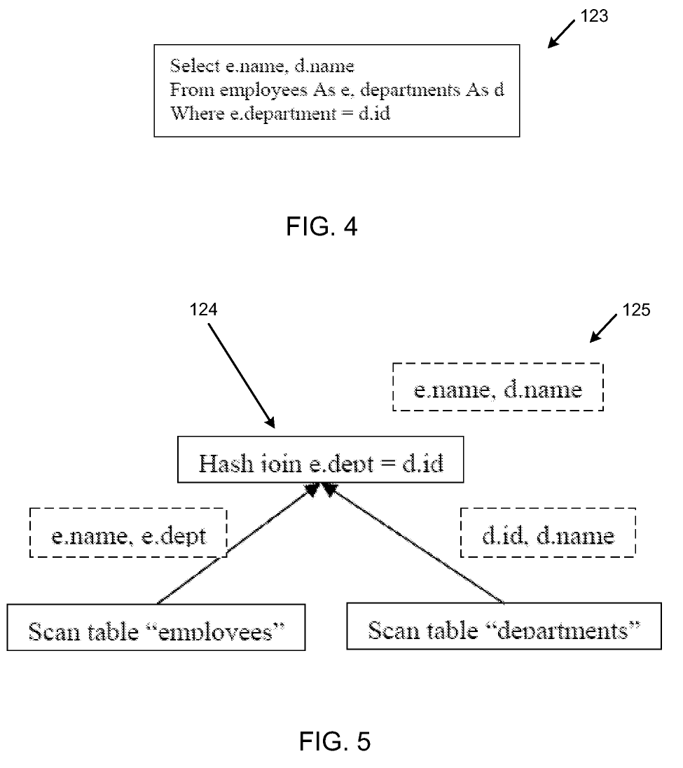

FIG. 4 illustrates a query 123 that joins two tables, according to an embodiment. An alternative syntax includes the join condition in the “from” clause rather than the “where” clause.

FIG. 5 illustrates an example of a query execution plan 124 for the query of FIG. 4, including the record formats 125 after each step, according to an embodiment.

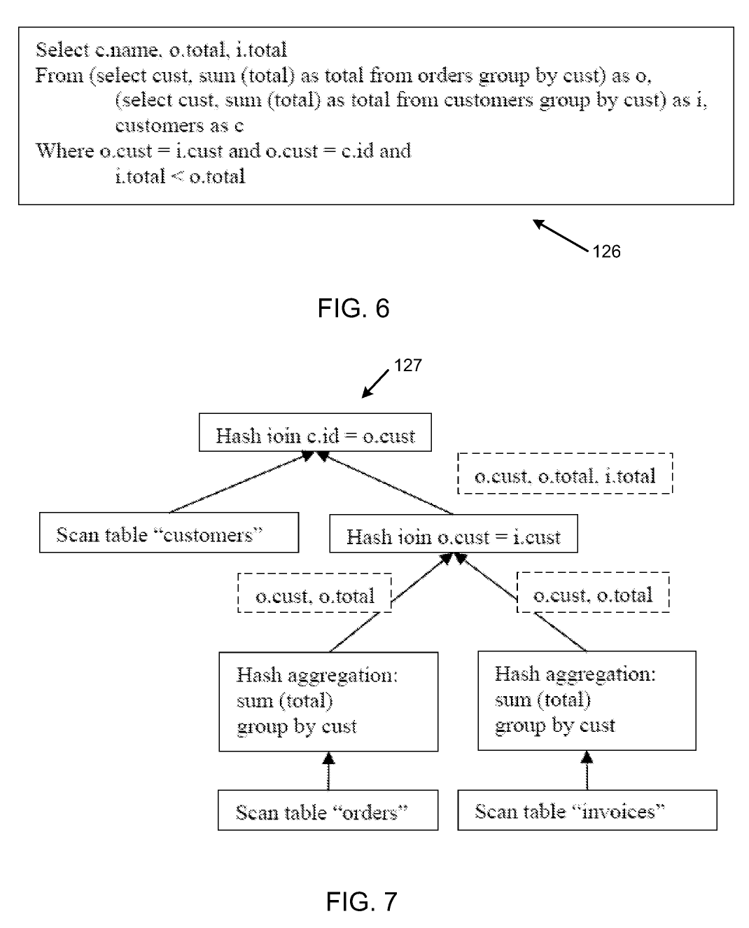

FIG. 6 illustrates a complex query 126, according to an embodiment. For the example discussed below for application of the system 100 for a query related to a number of customers for who more merchandise has been billed then ordered, the query 126 may print customer names with the total volume of all orders and of all invoices if the order volume exceeds the invoice volume, i.e., there are orders to be written. The query 126 uses three tables: from the “customers” table, a customer's name; from the “orders” table, the total order volume; and from the “invoices” table, the total invoice volume.

FIG. 7 illustrates an example of a query execution plan 127 for the query of FIG. 6, according to an embodiment. The aggregation operations and the join operation are separate operations. In the hash join, the build input is shown on the left and the probe input on the right. These names refer to the in-memory hash table central to any hash join process: the hash table is built with records from the build input; once the build task is complex, the hash table is probed (searched) with records from the probe input. For efficiency with respect to the hash table size and thus the overall memory allocation, the smaller one of the two join inputs is generally chosen as the build input.

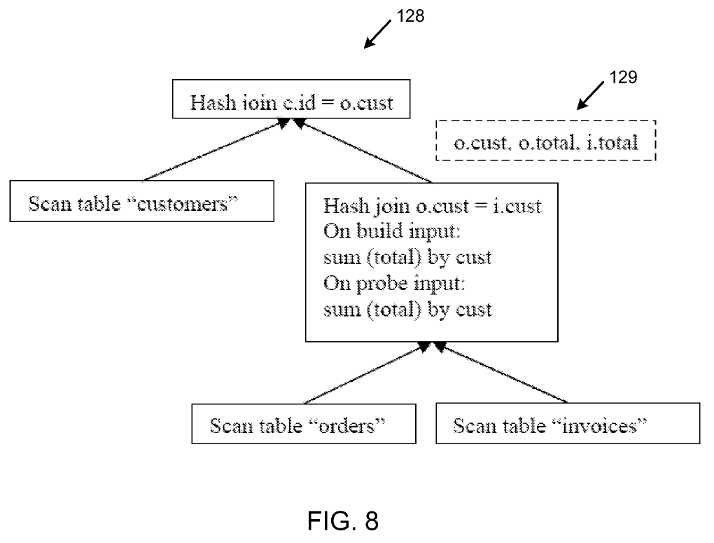

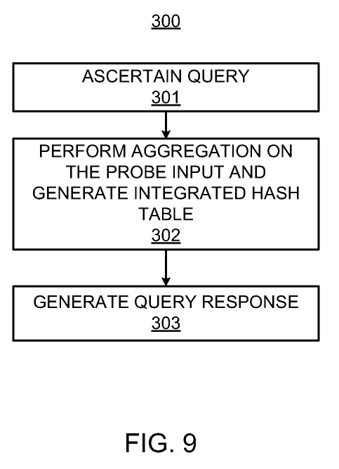

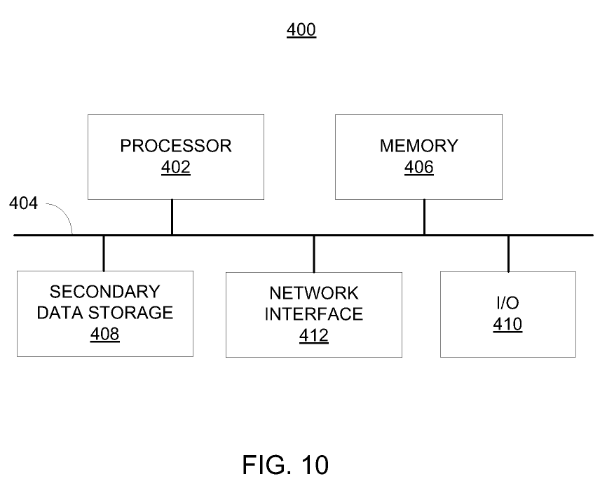

FIG. 8 illustrates an example of a query execution plan 128 for the complex query of FIG. 6, according to an embodiment. The query execution plan 128 is implemented by the system 100. For the query execution plan 128, records in the hash table absorb input records from both build and probe inputs, 107, 108, respectively, and contain intermediate aggregation information for both aggregation operations. In this example, the format for each output record 129 (dashed) is equal to the format for intermediate records in the hash table. If the aggregation function were “average” rather than “sum,” the intermediate records would include two sums and two counts. As described herein, aggregation only on the probe input 108 (but not on the build input 107) is also supported by the system 100. Aggregation in both build and probe inputs 107, 108, provides additional choices during query optimization.

Operation of the modules and components of the system 100 is described.

Referring to FIG. 1, generally, in order to perform aggregation on the probe input 108, or aggregation on both the build and probe inputs 107, 108, respectively, of the hash join module 101, aggregation may be performed by the hash aggregation module 102. For a given query 103, the system 100 may include appropriate information from the probe input 108 within records retained in the integrated hash table that is central to the hash join and hash aggregation modules, 101, 102, respectively. Final calculations may be performed by the system 100 when an output record is produced from a record in the integrated hash table.

As briefly discussed above, an example of an application of the system 100 for a query related to a number of customers for who more merchandise has been billed then ordered is described for facilitating a description of the modules 101, 102 and 106.

For a query related to a number of customers for who more merchandise has been billed then ordered, first, all orders may be evaluated. The order volume per customer may be aggregated. For example, referring to FIG. 1, the aggregation may be performed on the build input 107 of the hash join module 101 by the hash aggregation module 102. Then all invoices may be evaluated. The invoice volume per customer may be aggregated. For example, the aggregation may be performed on the probe input 108 of the hash join module 101 by the hash aggregation module 102. When both inputs are aggregated, the two aggregated values of order volume and invoice volume may be joined by the hash join module 101 to determine for which customers' more merchandise has been billed than ordered. The integrated hash table for the system 100 may include two sums. One sum may be a sum of order volume, and the second sum may be a sum of invoice volume. The build and probe inputs 107, 108, respectively, may be joined and aggregated as follows. First, the build input 107 may be consumed. After looking at the order and a customer ID, the customer ID may be hashed. In this regard, the system 100 may determine if a record exists with the same customer ID. If a record does not exist, then the input record may be placed in the hash table. If a matching record exists, aggregation may be performed on the input record and the matching record by the hash aggregation module 102. For aggregation, the order volume may be added for the particular customer ID. For the probe input 108, an invoice record may be evaluated. After locating the customer ID, the customer ID may be hashed. The system 100 may then locate a record with the same customer ID in the integrated hash table. If the customer ID is not located in the integrated hash table, the invoice record may be discarded (i.e. the customer ID or the invoice are not inserted in the integrated hash table). If the customer ID is located in the integrated hash table, invoices for that customer ID may be aggregated by the hash aggregation module 102. In this manner, both the build and probe inputs 107, 108, respectively, may be consumed. By inspecting the integrated hash table and inspecting all records that have accumulated, the number of customers for who more merchandise has been billed then ordered can be determined and output at the query response 109 by joining the two aggregated values of order volume and invoice volume by the hash join module 101. Thus instead of three operations of first computing the total order volume for each customer and storing the results in a first hash table, sending the results to the build input of a join operation, then computing the total invoice volume and storing the results in a second hash table, sending the results to the probe input of the join operation, and joining the two inputs and storing the results in a third hash table, the system 100 as described herein performs these three operations in one step by performing aggregation on the probe input 108, or aggregation on both the build and probe inputs 107, 108, respectively of the hash join module 101 and storing the results in a single integrated hash table.

As described above, in order to perform aggregation on the probe input 108, or aggregation on both the build and probe inputs 107, 108, respectively, of the hash join module 101, aggregation may be performed by the hash aggregation module 102. For a given query 103, the system 100 may include appropriate information from the probe input 108 within records retained in the integrated hash table that is central to the hash join and hash aggregation modules, 101, 102, respectively. In this regard, the records in the integrated hash table may include aggregates from the probe input. For the foregoing example, the records may include the sum of invoice amounts.

Final calculations may be performed by the system 100 when an output record is produced from a record in the hash table. For example, assuming that the foregoing example query is modified for finding customers where the average invoice amount is higher than the average order amount, instead of adding averages as in the foregoing example, for every new invoice and order, the sum and count may be incremented by one. After consuming the two inputs, the resulting integrated hash table may include records including the following five fields: customer ID, total invoice amount, count of invoices, total order amount and count of orders. The two averages related to invoice amount and order amount may be obtained by the respective totals divided by the counts, and compared accordingly. Thus the foregoing final calculations may include computation of averages from the sum and count values.

The integrated hash table constructed with records from the build input 107 may contain additional fields (not present or derived from the build input 107) in order to accommodate aggregated information from records of the probe input 108. The additional fields may accommodate the aggregation of records from the probe input 108. For example, in the foregoing example for a query related to the number of customers for who more merchandise has been billed then ordered, if the build input 107 is the orders and the probe input 108 is the invoices, in order to account for aggregation of the build and probe inputs 107, 108, appropriate fields would be used in those records. The fields may depend on the query 103 at hand. For example, the field may be unique to each query. For example, instead of querying invoices and orders as described above, if the particular query is related to internet users and their click-stream behavior, then the fields and input tables would relate to the query at hand. For example, the fields may be the same as the fields in an aggregation of the input in a query execution plan with a join and two separate aggregation operations. For the foregoing example of the query related to the number of customers for who more merchandise has been billed then ordered, without the implementation of the integrated hash table via the system 100, three separate operations each including a hash table may include a hash table for aggregation on the orders, a hash table for aggregation on the invoices, and a hash table for performing the join. For a specific query, the appropriate field for each of these three operations and their hash tables may be evaluated. These fields for the three individual operations and respective hash tables may be used in the integrated hash table for the system 100. These fields may include the grouping values and the partial aggregation values (e.g., a sum and a count). For example, as an unsorted input is consumed, at any given time, a partial aggregation may be performed. For the foregoing example of the query related to the number of customers for who more merchandise has been billed then ordered, for a particular customer, if for example, 7 out of 12 invoices have been evaluated, then the sum may include the sum of 7 invoices and the count may be incremented to 7. When the entire input is consumed, all 12 invoices may be evaluated and the count may be incremented to 12. Thus the partial aggregation values may be updated each time a new input record is seen. When all inputs are consumed, calculations may be performed on the final partial aggregation record.

Final calculations may be performed before output is produced. For example, the sum and count may be divided to obtain an average. For the foregoing example of the query related to the number of customers for who more merchandise has been billed then ordered, in order to determine the individual orders where the order volume is larger than the average invoice, on the build input (the orders), no aggregation may be performed (i.e. only individual orders are evaluated and groups are not collapsed into single summaries). On the probe input (the invoices), groups may be collapsed to obtain an average invoice. In order to process such a query with a single operation and a single hash table, the build input (the orders) may be consumed, and every oldest record may be inserted into the hash table. Once all records are inserted into the hash table, the probe input records may be consumed. For every probe input record with an individual invoice, an average invoice amount may be computed. For example, if a customer has submitted three orders, the average invoice amount may be computed for that customer in three places so that each of these orders in the hash table may be compared with the average invoice. Thus for a customer with three such orders, three order records may be placed in a hash table, an individual invoice record may be consumed, and in each of the three records in the hash table, the total invoice amount may be computed and the count of the invoices may be recorded. Upon completion, the three records may include the fields customer ID, individual order volume, total invoice volume, and invoice count. The total invoice volume may be divided by the invoice count to obtain an average invoice amount, and the average invoice amount may be compared to the individual order total. Based on the comparison, it can be determined if the order was or was not larger than the average invoice.

Each record of the probe input 108 may match with multiple records of the build input 107 and may therefore contribute to the aggregation calculations in multiple records in the hash table. Thus in order to perform aggregation on the probe input 108, the system 100 may include the integrated hash table including records that have sums from both inputs.

The integrated hash table used with the system 100 thus integrates the aggregation at the build input 108, or the two aggregations at the build and probe inputs 107, 108, and a subsequent join at the hash join module 101. Alternatively, instead of two aggregations at the build and probe inputs 107, 108, the system 100 may include aggregations from two inputs, and possibly multiple aggregations from each input. For example, for the foregoing example, a query may compute not only the average invoice amount but average, minimum, and maximum. The integrated hash table may contain records with fields. Each record in the integrated hash table may compute two aggregates. Thus for the foregoing example of the query related to the number of customers for who more merchandise has been billed then ordered, the records in the integrated hash table may contain the customer ID, the total order amount and total invoice amount. As records from the two inputs are consumed, the order amount and invoice amount may be incremented such that when all records from the inputs have been consumed, the totals may be compared as needed. More generally, for the probe input 108, or for each of the build and probe inputs 107, 108, an aggregation may be performed, with the results being joined by the hash join module 101. The aggregation and join operations may be focused on the same column set (i.e. in the foregoing example, the customer ID). The integrated hash table that integrates the two aggregations and join operation may contain intermediate records that contain all the grouping columns (i.e. in the foregoing example, the customer ID), all the aggregation columns for the build input 107 (i.e. in the foregoing example, the total orders), and all the aggregation columns for the probe input 108 (i.e. in the foregoing example, the total invoices). Thus, generally, for an operation involving multiple inputs (e.g. 1 to n inputs generally), the integrated hash table may likewise include a single record with aggregation columns from the n inputs.

Thus based on the foregoing example, aggregation may be performed on the probe input 108, or on both the build and probe inputs 107, 108, respectively of the hash join module 101. As discussed above, instead of three operations (two aggregation operations and one join operation, with role reversal supported in this join) or two operations (one aggregation and one join with integrated aggregation for the build input, with role reversal inhibited), for the system 100, a single operation may be performed (i.e. a join with aggregation on just the probe input or on both inputs) and role reversal in this join may be supported in case of mistaken cardinality estimation during compile-time query optimization. In another example, for a query search for customers for whom the oldest invoice pre-dates the oldest order, if cardinality estimation during compile-time query optimization anticipated fewer customers with orders than customers with invoices, yet run-time observation during query execution proves this estimate wrong (perhaps even for some partitions), then role reversal can reduce the memory allocation of the operation and also reduce the number of partitioning levels.

The system 100 thus provides for database query processing, for example, for ‘map-reduce’ data processing. The integrated hash table generated by the hash table generation module 106 may be used as the associative data structure. Other forms of in-memory search trees may also be used as the specific associative data structure. The information items may be individual records or rows in a table. The information items may also be complex objects represented in any computer-appropriate format. The information items may be packaged into sets in the inputs and outputs of the system 100, or processed one at a time within the system 100. The system 100 may also use a grouping operation such as a ‘group by’ query in ANSI SQL or a duplicate removal operation. The grouping operation may also cache parameters for a nested query or for a function, or cache parameters and results for a nested query or for a function. The join operation may also include any form of outer join in ANSI SQL, any form of semi join, or any form of binary set operation such as intersection. The intermediate result items may include multiple input items, and/or capture summary information about multiple input items. Multiple such operations may cooperate with each other and with other operations in a query execution plan or data flow plan. Further, items in the hash table may capture or summarize input items from multiple inputs. As discussed above, the sequence of inputs may be mutable, also known as role reversal in the special case of two inputs.

The system 100 thus provides for deep integration of aggregation and join operations as well as intermediate results records in the hash table that contain intermediate fields for multiple aggregations, e.g., sums and counts as appropriate for two separate average calculations. The inputs that require aggregation are consumed first. For each item, a match is sought in the hash table. If one is found, an appropriate aggregation action is performed. The appropriate aggregation action depends on the input from which the item originated. The intermediate record in the hash table may have multiple aggregation fields, each one associated with one of the inputs. For example, if averages are needed for two (or generally N) inputs, each intermediate record has two (N) sums (one for each input) and two (N) counts (one for each input).

If no match is found, the appropriate action depends on the join condition among the inputs and the processing sequence for inputs. If no match is found while the first input is consumed, a new record is inserted into the hash table. If no match is found while the second input is consumed, no match implies that the current input record fails the join predicate. The appropriate action depends on the type of join, i.e., inner join versus outer joins.

After consuming the inputs using aggregation, other join inputs may be consumed. The hash table may be probed for matches and actions may be taken as appropriate for the type of join and the complete join predicate, including predicates on the fields computed by aggregation.

### 3. Method

FIG. 2 illustrates a method 300 for hash integration, according to an embodiment. The method 300 is described with respect to the hash integration system 100 shown in FIG. 1 by way of example and not limitation. The method 300 may be performed by other systems.

At block 301, the system 100 may receive the query 103 and ascertain the requirements of the query. For example, the user 104 may present the query 103 pertaining to the data 105 to the system 100.

At block 302, based on the query, the system 100 may perform aggregation on the probe input 108, or aggregation on both the build and probe inputs 107, 108, respectively, of the hash join module 101, by the hash aggregation module 102, and generate the integrated hash table by the hash table generation module 106. For a given query 103, the system 100 may include appropriate information from the probe input 108 within records retained in the integrated hash table that is central to the hash join and hash aggregation modules, 101, 102, respectively. In this regard, the records in the integrated hash table may include aggregates from the probe input. The integrated hash table used with the system 100 thus integrates the two aggregations at the build and probe inputs 107, 108 (assuming aggregation is performed on both the build and probe inputs 107, 108), and a subsequent join at the hash join module 101. More generally, for just the probe input 108 or for each of the build and probe inputs 107, 108, an aggregation may be performed, with the results being joined by the hash join module 101. The aggregation and join operations may be focused on the same column set. As described above, the integrated hash table that integrates the two aggregations and join operation may contain intermediate records that contain all the grouping columns, all the aggregation columns for the build input 107, and all the aggregation columns for the probe input 108. Thus, generally, for an operation involving multiple inputs (e.g. 1 to n inputs generally), the integrated hash table may likewise include a single record with aggregation columns from the n inputs.

At block 303, the system 100 may generate the query response 109 based on the output of the hash join module 101.

### 4. Computer Readable Medium

FIG. 3 shows a computer system 400 that may be used with the embodiments described herein. The computer system 400 represents a generic platform that includes components that may be in a server or another computer system. The computer system 400 may be used as a platform for the system 100. The computer system 400 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes a processor 402 that may implement or execute machine readable instructions performing some or all of the methods, functions and other processes described herein. Commands and data from the processor 402 are communicated over a communication bus 404. The computer system 400 also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums.

The computer system 400 may include an I/O device 410, such as a keyboard, a mouse, a display, etc. The computer system 400 may include a network interface 412 for connecting to a network. Other known electronic components may be added or substituted in the computer system 400.

While the embodiments have been described with reference to examples, various modifications to the described embodiments may be made without departing from the scope of the claimed embodiments.

1. A hash integration system comprising:
a processor;
a hash join module including build and probe inputs;
a hash aggregation module to aggregate on the probe input of the hash join module; and
a hash table generation module, executed by the processor, to generate an integrated hash table including a record with values from the build and aggregated probe inputs,
wherein the hash join module joins the build and aggregated probe inputs to form a joined output.

2. The system of claim 1, wherein the hash aggregation module aggregates on the build and probe inputs of the hash join module, and the hash table generation module generates the integrated hash table including the record with values from the aggregated build and probe inputs.

3. The system of claim 2, wherein the integrated hash table includes an aggregation column for the build input.

4. The system of claim 1, wherein the integrated hash table includes an aggregation column for the probe input.

5. The system of claim 1, wherein the integrated hash table includes a column common to operation of the hash aggregation and hash join modules.

6. The system of claim 1, wherein the system includes a single memory allocation for the integrated hash table.

7. The system of claim 1, wherein the system includes a single memory allocation for operation of the hash aggregation and hash join modules.

8. The system of claim 1, wherein the system permits role reversal of the build and probe inputs.

9. The system of claim 1, wherein fields in the integrated hash table are unique to a query to the system.

10. A method for hash integration comprising:
aggregating on a probe input of a hash join including a build input and the probe input;
generating, by a processor, an integrated hash table including a record with values from the build and aggregated probe inputs; and
joining the build and aggregated probe inputs to form a joined output.

11. The method of claim 10, further comprising aggregating on the build and probe inputs of the hash join, and generating the integrated hash table including the record with values from the aggregated build and probe inputs.

12. The method of claim 11, wherein the integrated hash table includes an aggregation column for the build input.

13. The method of claim 10, wherein the integrated hash table includes an aggregation column for the probe input.

14. The method of claim 10, further comprising providing a single memory allocation for the integrated hash table.

15. The method of claim 10, further comprising role reversal of the build and probe inputs.

16. The method of claim 10, wherein fields in the integrated hash table are unique to a query.

17. A non-transitory computer readable medium storing machine readable instructions, that when executed by a computer system, perform a method for hash integration, the method comprising:
aggregating on a probe input of a hash join including a build input and the probe input;
generating, by a processor, an integrated hash table including a record with values from the build and aggregated probe inputs; and
joining the build and aggregated probe inputs to form a joined output.

18. The computer readable medium of claim 17, further comprising aggregating on the build and probe inputs of the hash join, and generating the integrated hash table including the record with values from the aggregated build and probe inputs.

19. The computer readable medium of claim 18, wherein the integrated hash table includes an aggregation column for the build input.

20. The computer readable medium of claim 17, wherein the integrated hash table includes an aggregation column for the probe input.
